(19) United States
(12) Patent Application Publication
(10) Pub. No.: US 2013/0328399 A1
(43) Pub. Date: Dec. 12, 2013

(54) METHOD FOR REDUCING THE NUMBER OF POWER TERMINAL CONNECTORS

(71) Applicant: LENOVO (SINGAPORE) PTE. LTD., SINGAPORE (SG)

(72) Inventors: KEIJI SUZUKI, KANAGAWA-KEN (JP); HIDEKAZU CHUJO, TOKYO (JP)

(73) Assignee: LENOVO (SINGAPORE) PTE. LTD., SINGAPORE (SG)

(21) Appl. No.: 13/871,088

(22) Filed: Apr. 26, 2013

(30) Foreign Application Priority Data
Jun. 8, 2012 (JP) JP2012-130556

(51) Int. Cl. G06F 1/16; H02J 1/00

(52) U.S. Cl. CPC G06F 1/1654; G06F 1/16; G06F 1/1601; G06F 1/1613; H02J 1/00
USPC 307/29; 361/679.02; 361/679.56; 361/679.21; 361/679.55

(57) ABSTRACT

A method for reducing the number of connectors for connecting a tablet unit and a base unit is disclosed. The tablet unit includes a system device and a first connector connected to a power line for supplying power from the base unit. The base unit includes a second connector configured to be connected to the first connector when the base unit is combined with the tablet unit. The tablet unit also includes a battery unit capable of supplying power to the system device through the power line. An external power-supply circuit is also capable of supplying power to the system device from an AC/DC adapter through the power line. Since power can be supplied from the battery unit or the AC/DC adapter to the tablet unit through the power line alone, the number of connector terminals can be reduced.

### PRIORITY CLAIM

The present application claims benefit of priority under 35 U.S.C. §§120, 365 to the previously filed Japanese Patent Application No. JP2012-130556 with a priority date of Jun. 8, 2012, which is incorporated by reference herein.

### BACKGROUND OF THE INVENTION

1. Technical Field

The present invention relates to power terminals connectors in general, and more particularly to a technique for reducing the number of power terminal connectors for connecting a portable electronic device to a function expansion device.

2. Description of Related Art

Portable electronic devices include laptop personal computers (PCs), tablet terminals, smartphones, and the like. A laptop PC has many features that are suitable for handling many different tasks, such as handling data entries that involve a large amount of data using a mouse, a keyboard, and the like as input devices. However, a laptop PC is somewhat inconvenient to be carried around because of its size and weight when compared to a tablet terminal. A laptop PC also has a higher power consumption than a tablet terminal.

In contrast, tablet terminals have less features than laptop PCs, but they are more convenient for their intended use, such as browsing Internet sites, video viewing through a touch screen, and/or running an application. Therefore, a user typically chooses to use a laptop PC and a tablet terminal, depending on the intended use.

A hybrid PC is so configured that a display part can be detached from a main body. When the display part is detached as a single body from the main body, the hybrid PC functions as a tablet terminal, and when the display part is attached to the main body, the hybrid PC functions as a laptop PC. In the following, the display part in the hybrid PC is called a tablet unit, and the other parts including a keyboard and a display supporting part are collectively called a base unit.

FIG. 11 is a block diagram of a power system within a conventional hybrid PC. As shown, the conventional hybrid PC includes a tablet unit 50 and a base unit 60. The tablet unit 50 is equipped with a system device 53 and battery units 57, 58, and the base unit 60 is equipped with a system device 63 without any battery unit. When the tablet unit 50 and the base unit 60 are combined by connecting a connector 59 to a connector 69, power supply routes are connected as follows.

When an AC/DC adapter 62 is connected to a power supply jack 61 of the base unit 60, the AC/DC adapter 62 supplies power to the system device 53 of the tablet unit 50 through a power path 71, and further supplies power to a charger 55 to charge the battery units 57, 58. In addition, the AC/DC adapter 62 supplies power to the system device 63 through a power path 72. When the AC/DC adapter 62 is disconnected from the power supply jack 61, the battery units 57, 58 supply power to the system device 53 through power paths 73, 74, and further supply power to the system device 63 through a power path 75.

Here, to develop a new hybrid PC equipped with a battery unit and a system device in the base unit, the power system is considered to add a system device to the base unit 20 in FIG. 10 or to add a battery unit to the base unit 60 in FIG. 11. The system device of the base unit needs to be connected to the system device of the tablet unit via connectors. When the power system shown in FIG. 10 or FIG. 11 is adopted for the new hybrid PC, a power line of a battery unit, a power line of an AC/DC adapter, and a signal line of a system device are connected to a connector of the base unit to increase the number of terminals, resulting in a problem of making mounting difficult.

Further, the hybrid PC may be so used that it is carried around in such a state that the base unit and the tablet unit are combined, and at a destination where the AC/DC adapter cannot be used, only the tablet unit is used. In this case, when the battery unit of the tablet unit is discharged, the tablet unit cannot be used. However, when an amount of electricity remains in the battery unit of the base unit, it is convenient if the amount of electricity is used for the tablet unit. However, in the power system of FIG. 10, there is no power path to supply power from the battery unit 27 of the base unit 20 to the charger 15 of the tablet unit 10.

### SUMMARY OF THE INVENTION

It would be desirable to enable charging of a battery unit loaded in a first unit with a battery unit loaded in a second unit in such a power system. It is also desirable to make effective use of electricity of the battery loaded in the second unit to extend the operation time of the first unit.

In accordance with a preferred embodiment of the present disclosure, a tablet unit includes a system device and a first connector connected to a power line for supplying power from a base unit. The base unit includes a second connector configured to be connected to the first connector when the base unit is combined with the tablet unit. The tablet unit also includes a battery unit capable of supplying power to the system device through the power line. An external power-supply circuit is also capable of supplying power to the system device from an AC/DC adapter through the power line. Since power can be supplied from the battery unit or the AC/DC adapter to the tablet unit through the power line alone, the number of connector terminals can be reduced.

All features and advantages of the present disclosure will become apparent in the following detailed written description.

### BRIEF DESCRIPTION OF THE DRAWINGS

The disclosure itself, as well as a preferred mode of use, further objects, and advantages thereof, will best be understood by reference to the following detailed description of an illustrative embodiment when read in conjunction with the accompanying drawings, wherein:

FIGS. 1A-1C are perspective views of a hybrid PC;

FIG. 2 is a block diagram of a power system in the hybrid PC from FIG. 1;

FIG. 3 is a diagram describing power feeding routes from an AC/DC adapter in a combined state;

FIG. 4 is a flowchart describing the operation of a base unit and a tablet unit when the AC/DC adapter from FIG. 3 is connected in the combined state;

FIG. 5 is a chart showing an example of voltage profiles of battery units in the case of charging with the AC/DC adapter from FIG. 3;

FIG. 6 is a block diagram describing power feeding routes from the battery unit in the combined state;

FIG. 7 is a block diagram describing power feeding routes from the battery unit in the combined state;

FIG. 8 is a flowchart describing the operation of the base unit and the tablet unit when the AC/DC adapter from FIG. 3 is not connected in the combined state;

FIG. 9 is a chart showing an example of voltage profiles when the battery units are discharged;

FIG. 10 is a block diagram of a power system in a first conventional hybrid PC; and

FIG. 11 is a block diagram of a power system in a second conventional hybrid PC.

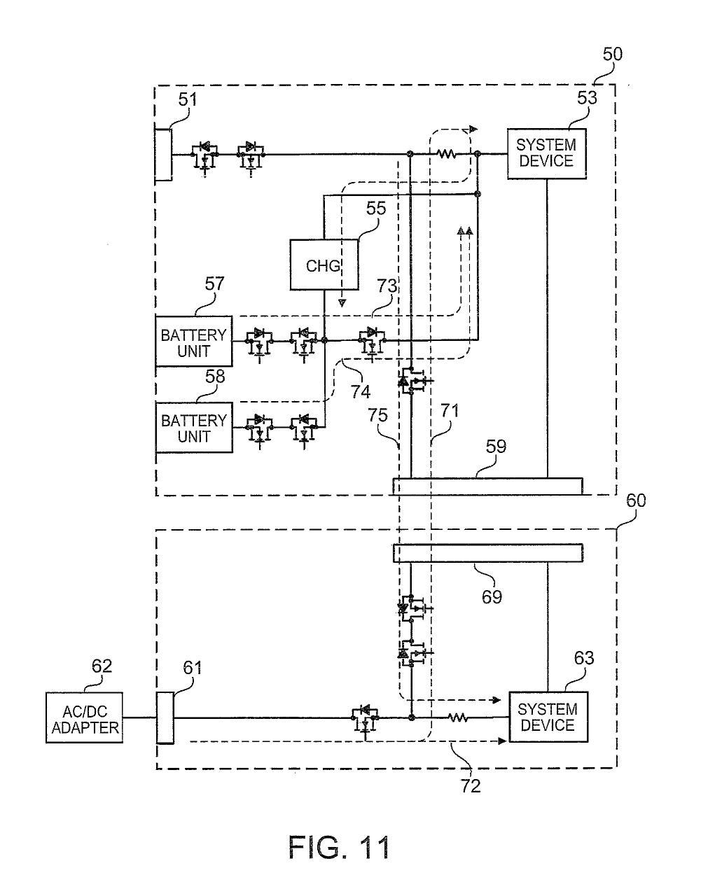

### DETAILED DESCRIPTION OF A PREFERRED EMBODIMENT

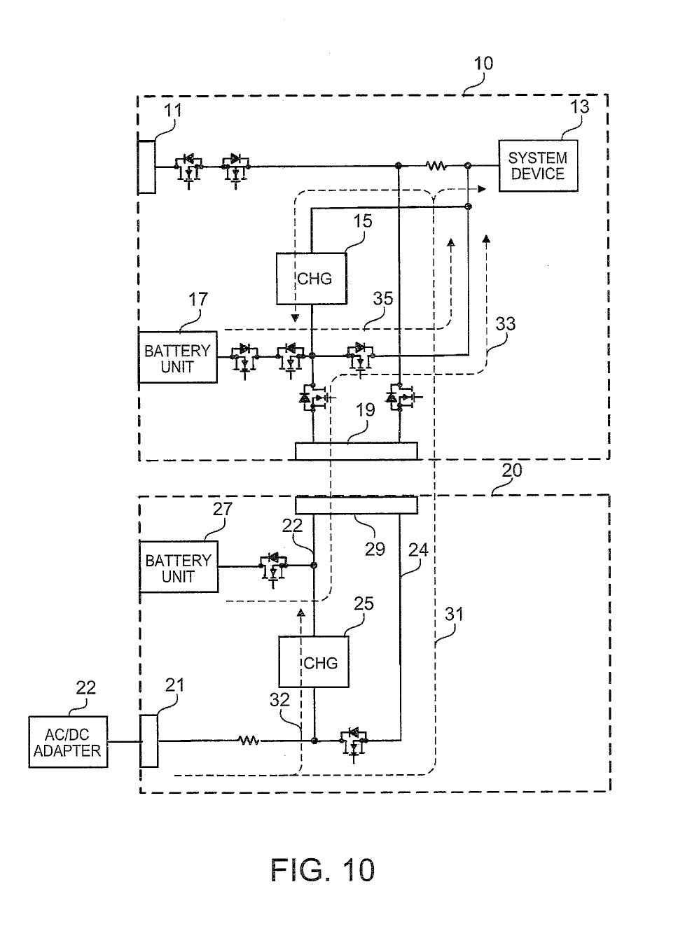

FIG. 10 is a block diagram of a power system in a first conventional hybrid personal computer (PC). As shown, a hybrid PC has a variety of devices mounted in a tablet unit 10 and a base unit 20. The tablet unit 10 is equipped with a system device 13 and a battery unit 17, and the base unit 20 is equipped with a battery unit 27 but without any system device.

Power supply routes when the tablet unit 10 is combined with the base unit 20 to connect a connector 19 and a connector 29 are as follows. First, when an AC/DC adapter 22 is connected to a power supply jack 21 of the base unit 20, the AC/DC adapter 22 supplies power to the system device 13 of the tablet unit 10 through a power path 31, and further supplies power to a charger 15 to charge a battery unit 17.

In addition, the AC/DC adapter 22 supplies power to a charger 25 through a power path 32 to charge a battery unit 27. When the AC/DC adapter 22 is disconnected from the power supply jack 21, the battery unit 27 supplies power to the system device 13 through a power path 33 to use the power at the destination. Further, when the remaining capacity of the battery unit 27 runs out, the battery unit 17 supplies power to the system device 13 through a power path 35. Thus, the base unit 20 supplies power to the tablet unit 10 from the battery unit 27 using a power line 22 or from the AC/DC adapter 22 using a power line 24.

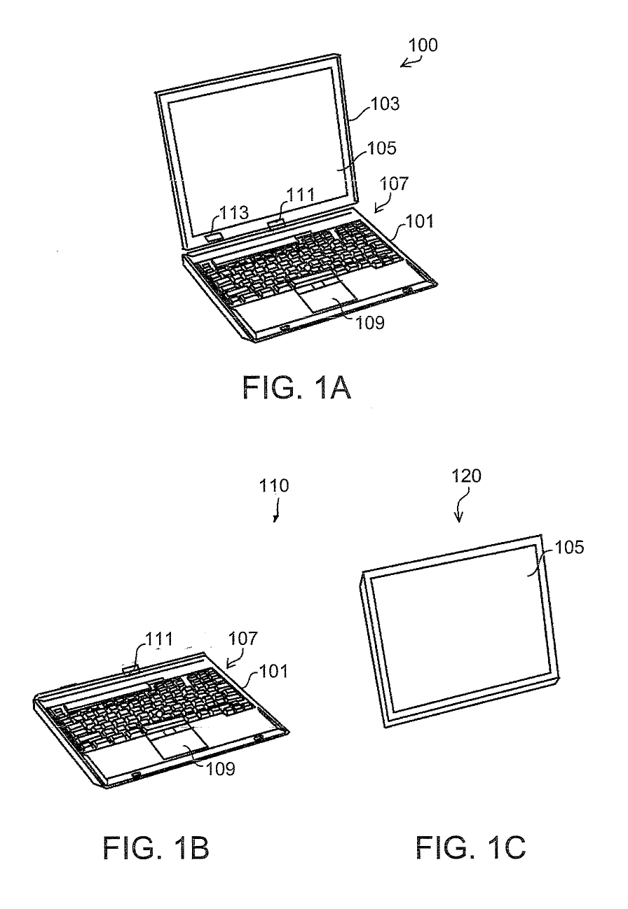

FIG. 1 is a perspective view of a hybrid PC 100, in accordance with a preferred embodiment of the present invention. The hybrid PC 100 is made up of a tablet unit 120 and a base unit 110 formed with casings capable of being physically detached from and combined with each other. FIG. 1A shows the tablet PC 100 in such a state that the tablet unit 120 is combined with the base unit 110, FIG. 1B shows the base unit 110 in a detached state, and FIG. 1C shows the tablet unit 120 in the detached state. In the following, the state of FIG. 1A is called the combined state, and the state of FIGS. 1B/1C is called the detached state.

The tablet unit 120 is equipped with a touch screen 105 made up of a display and touch sensors on the surface of the casing, and a system device functioning as a tablet terminal in the detached state is mounted in the casing. The base unit 110 is made up of a system casing 101 and a supporting member 103 combined with each other by a hinge 111. A user can operate an eject switch 113 to detach the tablet unit 120 from the supporting member 103.

Provided on the top face of the system casing 101 are a keyboard 107 and a touch-pad 109 as input devices, external connectors, not shown, such as a USB, an external display, and the Ethernet (registered trademark), and a power supply jack for connecting an AC/DC adapter. These devices mounted on the surface of the system casing 101 are called surface-mounted devices. The system casing 101 is equipped with a system device therein.

In an example, a system device including a processor with low power consumption and simple functionality can be mounted in the tablet unit 120, and a system device including a processor with high power consumption and advanced functionality can be mounted in the system casing 101. Then, the hybrid PC 100 can be configured to use the system device mounted in the system casing 101 at all times in the combined state or to switch between the system device of the tablet unit 120 and the system device of the system casing 101 automatically depending on the magnitude of the load.

In another example of system devices, a CPU, a main memory, a chipset, radio module, an SSD, and the like can be mounted in the tablet unit 120, and surface-mounted devices as peripheral devices for supplementing the functionality of the tablet unit 120, controllers for the surface-mounted devices, and a disk drive, such as an HDD or an ODD, can be mounted in the system casing 101 with no CPU and main memory mounted therein. In still another example, only the surface-mounted devices can be mounted on the system casing 101 and system devices can be all mounted in the tablet unit 120. Note that the forms of mounting the system devices in the tablet unit 120 and the system casing 101 to apply the present invention are not limited in the scope illustrated and described here.

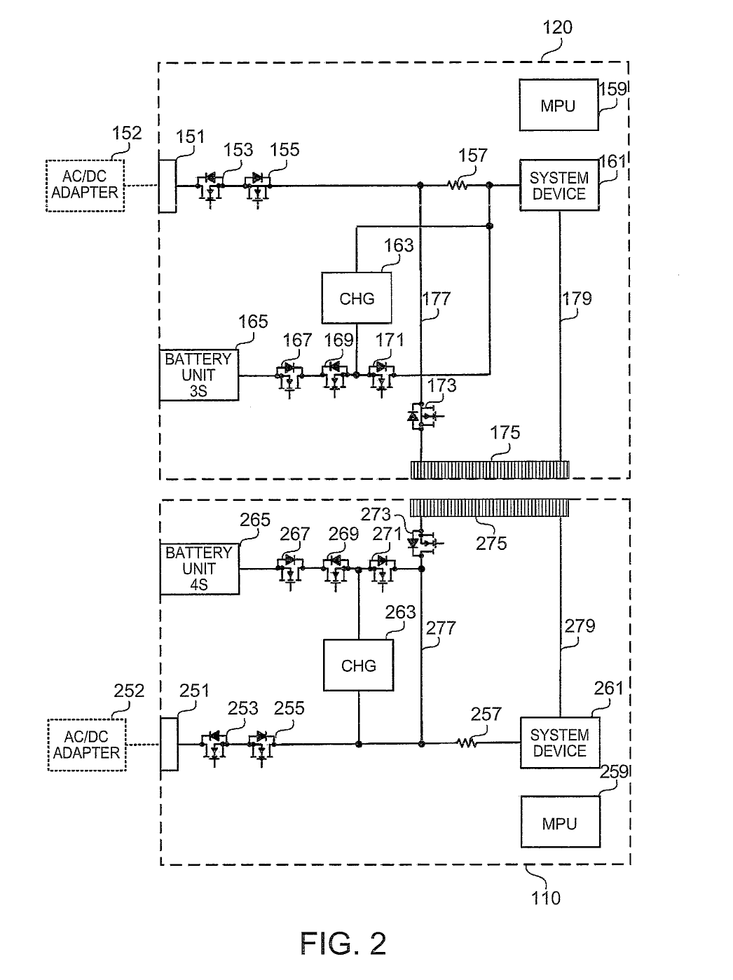

FIG. 2 is a block diagram of a power system within the tablet PC 100. First, description will be made of the tablet unit 120. FETs 153, 155 and a current sensing resistor 157 are connected in series between a power supply jack 151 and a system device 161. A connection point between the current sensing resistor 157 and the FET 155 is connected to a power terminal of a connector 175 via a power line 177 and an FET 173. FETs 167, 169, and 171 are connected in series between a connection point of the current sensing resistor 157 and a system device 161, and a battery unit 165.

The connection point between the current sensing resistor 157 and the system device 161 is further connected to the input of a charger 163. The output of the charger 163 is connected to a connection point between the FET 169 and the FET 171. The system device 161 is connected to a signal terminal of a connector 175 through a signal line 179. Note that the description of connections of MPUs 159 and 259 to other devices is omitted in FIG. 2.

The power supply jack 151 can be connected to an AC/DC adapter 152 in a detached state. In a combined state, the power supply jack 151 is positioned to be hidden behind the base unit 110 so that the power supply jack 151 cannot be connected to the AC/DC adapter 152. The AC/DC adapter 152 supplies, to the system device 161, power received from a commercial power supply, and further to the charger 163 to charge the battery unit 165.

The system device 161 is made up of a CPU, a GPU, a main memory, a chipset, a radio module, an SSD, and the like. The charger 163 is made up of an FET performing a synchronous rectification type of switching operation, a reactor and a capacitor as a smoothing circuit, a sensing resistor for measuring output voltage and output current, and the like. The charger 163 operates in a constant-current constant-voltage control (CCCV) system to conform the output current or the output voltage measured by itself to a set charging parameter in order to charge the battery unit 165.

The battery unit 165 is made up of three lithium ion battery cells connected in series, a protection circuit, an MPU, and the like. The battery unit 165 is an internal power supply for the tablet unit 120, and the base unit 110 and the AC/DC adapter 152 are external power supplies. When an external power supply is interrupted, the battery unit 165 supplies power to the system devices 161 and 261.

The MPU 159 runs a firmware to monitor and control the power and temperature of the tablet unit 120 in an environment independent of the system device 161. The MPU 159 monitors the combined state of the tablet unit 120 and the base unit 110, the remaining capacity of the battery unit 165, the connected state of the AC/DC adapter 152, and the like to control the operation of the FETs 153, 155, 167, 169, 171, and 173.

When the supply of power through the AC/DC adapter 152 is stopped to shift the peak of the commercial power supply depending on the time zone or according to an instruction from an administrator through a network, the MPU 159 turns the FET 153 off. When supplying power from the battery unit 165 or the base unit 110 to the system device 161, the MPU 159 turns the FET 155 off not to apply voltage to the AC/DC adapter 152.

In order to limit the output power of the AC/DC adapter 152 to a rated capacity, the MPU 159 measures voltage between both ends of the current sensing resistor 157 to calculate the total power consumption of the system device 161 and the charger 163, and makes the tablet unit 120 transit to a power saving mode if needed. From the voltage at the power terminal of the connector 175 to which the power line 177 is connected, or through a mechanical switch, or through communication with the MPU 259, the MPU 159 determines whether the state is the detached state or the combined state. When determining that the state is the detached state, the MPU 159 turns the FET 173 off, while when determining that the state is the combined state, the MPU 159 turns the FET 173 on.

The MPU 159 is connected to the battery unit 165 via a communication bus. The MPU 159 sets, in the charger 163, a charging parameter received from the battery unit 165 or monitors the charged state to control charging of the battery unit 165. The MPU 159 can change the charging parameter when the charger 163 operates with constant current to control the charging power. When the battery unit 165 is charged with electricity from the AC/DC adapter 152 or electricity from the base unit 110, the MPU 159 turns the FET 171 off. When power is supplied from a battery unit 265 to the system device 161 in the combined state, the MPU 159 controls the FETs 167 and 169 to prevent short current between batteries.

The connector 175 is made up of multiple terminals of the same standard. Among the terminals, multiple signal terminals connected to the signal line 179 and multiple power terminals connected to the power line 177 are allocated. As an example of power terminals to compensate for shortage of current capacity, when the maximum current of the power line 177 is 3 A, if the rated capacity of one terminal is set to 1 A and reduced up to 50 percent for safety sake, the number of terminals for two power lines 177 will be two lines×(3 A/0.5 A), i.e., 12.

Next, the base unit 110 will be described. FETs 253, 255, and a current sensing resistor 257 are connected in series between a power supply jack 251 and a system device 261. A connection point between the FET 255 and the current sensing resistor 257 is connected to a power terminal of a connector 275 via the input of a charger 263, a power line 277, and an FET 273. FETs 267, 269, and 271 are connected in series between a battery unit 265 and a connection point between the FET 273 and the current sensing resistor 257. The output of the charger 263 is connected to a connection point between the FET 269 and the FET 271. The system device 261 is connected to a signal terminal of the connector 275 through a signal line 279.

The power supply jack 251 can be connected to an AC/DC adapter 252 in both the detached state and the combined state. In the combined state, only the AC/DC adapter 252 is an external power supply for the tablet PC 100 to supply power to the system device 261 and the charger 263 of the base unit 110, and to the system device 161 and the charger 163 of the tablet unit 120.

The system device 261 can be configured in various ways as mentioned above. As an example, the base unit 110 can be configured not to function in the detached state. In this case, the AC/DC adapter 252 supplies power only to the charger 263 without supplying power to the system device 261. Alternatively, an external display may be connected to the base unit 110 so that the system device 261 will function even in the detached state. In this case, the AC/DC adapter 252 supplies power to the system device 261 and the battery unit 265 even in the detached state.

The charger 263 has the same configuration as the charger 163 to charge the battery unit 265. The battery unit 265 is made up of four lithium ion battery cells connected in series, a protection circuit, an MPU, and the like. The battery unit 265 is an internal power supply for the base unit 110, and the AC/DC adapter 252 and the battery unit 165 are external power supplies. In this example, the output voltage of the battery unit 265 is higher by one cell than the output voltage of the battery unit 165. The battery unit 265 supplies power to the charger 163, and the system devices 161, 261.

The MPU 259 runs a firmware to monitor and control the power and temperature of the base unit 110 in an environment independent of the system device 261. The MPU 259 can communicate with the MPU 159. The MPU 259 monitors the combined state of the tablet unit 120 and the base unit 110, the remaining capacity of the battery unit 265, and the connected state of the AC/DC adapter 152, and the like to control the operation of the FETs 253, 255, 267, 269, 271, and 273. From the voltage at the power terminal of the connector 275 to which the power line 277 is connected, or through a mechanical switch, or through communication with the MPU 159, the MPU 259 determines whether the state is the detached state or the combined state. When determining that the state is the detached state, the MPU 259 turns the FET 273 off, while when determining that the state is the combined state, the MPU 259 turns the FET 273 on.

When the peak of the commercial power supply is shifted, the MPU 259 turns the FET 253 off. When power is supplied from the battery unit 165 or the battery unit 265 to the system device 261, the MPU 259 turns the FET 255 off so that no voltage will be applied to the AC/DC adapter 252. The MPU 259 measures voltage between both ends of the current sensing resistor 257, and further controls the operation mode of the base unit 110 based on information on the power consumption of the system device 161 and the charging power of the battery unit 165 received from the MPU 159 so that the output power of the AC/DC adapter 252 will fall within the rated capacity.

The MPU 259 is connected to the battery unit 265 via the communication bus to acquire the remaining capacity and notify the MPU 159 of the remaining capacity, and to acquire a charging parameter and set the charging parameter in the charger 263. The MPU 259 sets, in the charger 263, the charging parameter received from the battery unit 265 or monitors the charged state to control charging of the battery unit 265. The MPU 159 can change the charging parameter when the charger 263 operates with constant current to control the charging power.

When the battery unit 265 is charged with the AC/DC adapter 252, the MPU 259 turns the FET 271 off. When power is supplied from the battery unit 165 to the system device 261 in the combined state, the MPU 259 controls the FETs 267 and 269 to prevent short current between batteries. The connector 275 includes multiple terminals corresponding the multiple power terminals and signal terminals of the connector 175 connected to the connector 175 in the combined state. The number of terminals that can be provided in the connectors 175 and 275 is limited depending on the physical size of the tablet unit 120. As the number of signal lines for the signal lines 179 and 279 increases, the terminals of the connectors 175 and 275 may run short, affecting the configuration of the system device 261.

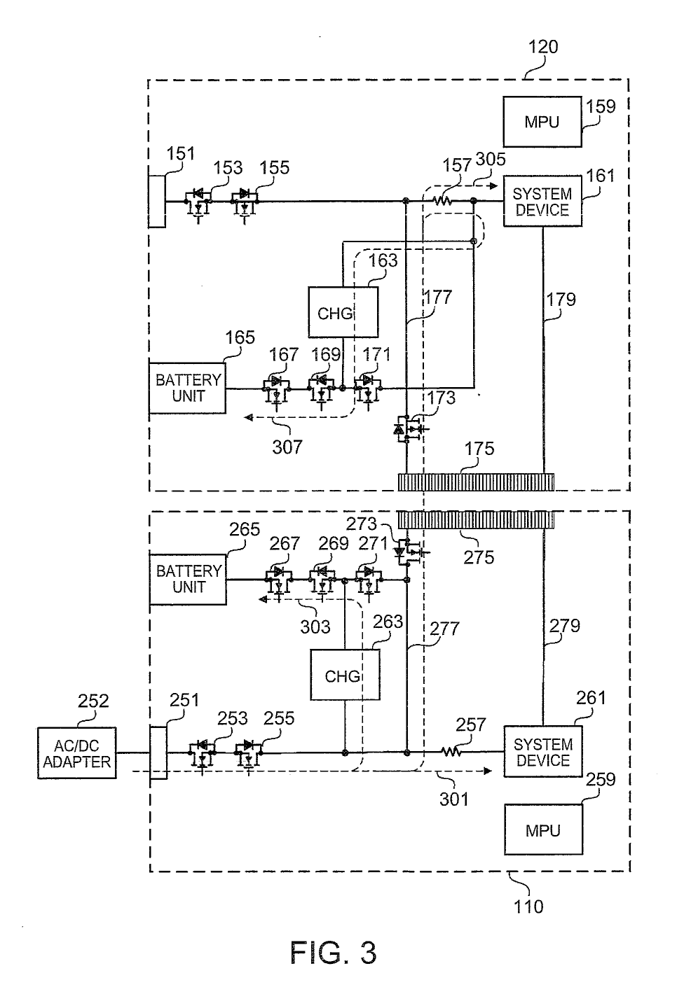

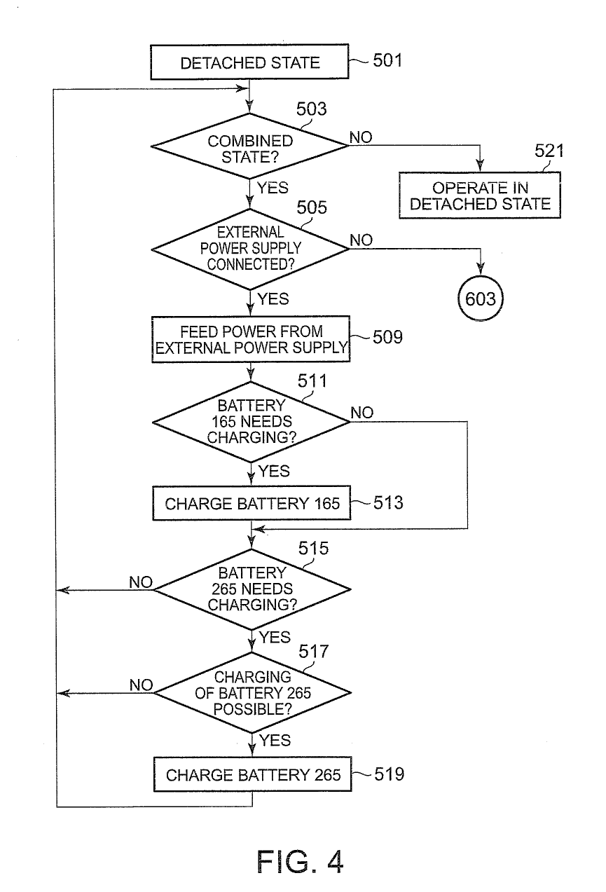

FIG. 3 is a diagram describing power feeding routes from the AC/DC adapter 252 in the combined state, and FIG. 4 is a flowchart for describing the operation of the base unit 110 and the tablet unit 120 when the AC/DC adapter 252 is connected in the combined state. In block 501, the AC/DC adapters 152 and 252 are not connected to the power supply jacks 151 and 251 in the detached state.

The FETs 253, 267, 269, and 271 of the base unit 110 are tuned on and the FETs 255 and 273 are turned off. As a result, the battery unit 265 supplies power to the system device 261. Further, the FETs 153, 167, 169, and 171 of the tablet unit 120 are turned on and the FETs 155 and 173 are turned off. As a result, the battery unit 165 supplies power to the system device 161. After that, the user attaches the tablet unit 120 to the base unit 110.

In block 503, the MPUs 159 and 259 determine whether the state is the combined state or the detached state, respectively. In the detached state, the operation in the detached state continues in block 521, respectively, while in the combined state, the procedure proceeds to block 505. In block 505, the MPU 259 turns the FET 273 on so that power can be fed to the tablet unit 120. Further, the MPU 259 detects voltage at the power supply jack 251 to determine whether the AC/DC adapter 252 is connected or not.

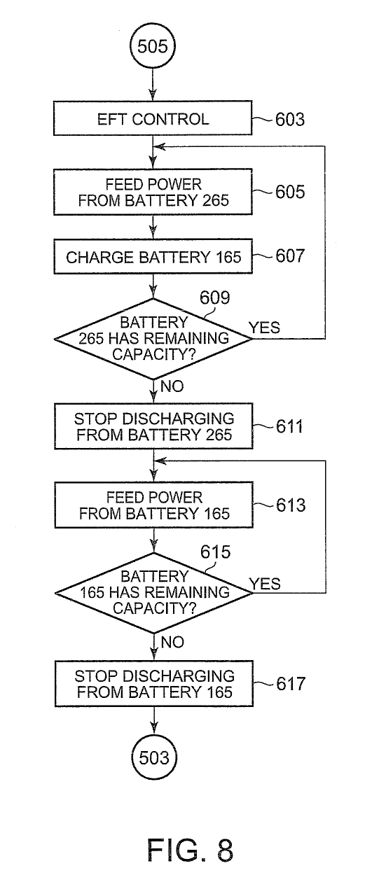

From the voltage at the power terminal of the connector 175, the MPU 159 determines whether the base unit 110 as the external power supply is connected. When the MPUs 159 and 259 do not detect the connection of an external power supply, the procedure proceeds to block 603 in FIG. 8, while when they detect the connection, the procedure proceeds to block 509. In block 509, the MPU 259 turns the FET 255 on, and the MPU 159 turns the FET 173 on. The AC/DC adapter 252 supplies power to the system device 261 through a power path 301 in FIG. 3, and supplies power to the system device 161 through a power path 305.

Here, the relations among the rated capacity of the AC/DC adapter 252, the power consumptions of the system devices 161 and 261, and the charging power of the battery units 165 and 265, and the order of charging will be described. In order to prevent the rated capacity of the AC/DC adapter 252 from being too much, battery charger controls system input current from AC/DC adapter 252 to be smaller than the sum of the maximum power consumptions of the system devices 161, 261 and the battery units 165, 265 and larger than the sum of the maximum power consumptions of the system device 161 and the system device 261.

In the combined state, the MPU 259 applies, as charging power of the battery units 165, 265, an amount of power corresponding to a difference between the rated capacity of the AC/DC adapter 252 and the sum of the power consumptions of the system devices 161, 261. Further, when the state comes into the detached state, the MPU 259 gives priority to charging of the battery unit 165 over charging of the battery unit 265 to extend the operation time when the tablet unit 120 operates with the battery unit 165.

In block 511, the MPU 159 determines whether the battery unit 165 needs charging. When there is no need for charging, the procedure proceeds to block 515, while when there is a need for charging, the procedure proceeds to block 513 in which the MPU 159 turns the FET 171 off, sets a charging parameter in the charger 163, and supplies charging power through a power path 307 in FIG. 3 to charge the battery unit 165. At this time, the MPU 159 sets the charging parameter based on the rated capacity of the AC/DC adapter 252 received from the MPU 259, and the power consumption of the system device 161 measured by detecting the power consumption of the system device 261 and the voltage across the current sensing resistor 157. When charging is finished, the MPU 159 stops the operation of the charger 163 and turns the FET 171 on.

In block 515, the MPU 259 determines whether the battery unit 265 needs charging. When there is no need for charging, the procedure returns to block 503, while when there is a need for charging, the procedure proceeds to block 517. In block 517, the MPU 159 communicates with the MPU 159 to acquire the power consumption of the system device 161 and the charging power of the charger 163, and further acquires the power consumption of the system device 261 to determine whether there is a margin in the rated power of the AC/DC adapter 252 to charge the battery unit 265.

When the sum of the power consumptions of the system devices 161, 261 and the charging power of the battery unit 165 is equal to or larger than a certain value, since this means that there is no margin to charge the battery unit 265, the procedure returns to block 503. When charging is possible, the MPU 259 turns the FET 271 off in block 519. Further, the MPU 259 sets a charging parameter in the charger 263 to provide an acceptable charging power to charge the battery unit 265. After that, the procedure returns to block 503. When charging is finished, the MPU 259 turns the FET 271 on. At this time, charging power is supplied through a power path 303 in FIG. 3.

The MPU 259 can communicate with the MPU 159 periodically to calculate a power margin in the AC/DC adapter 252 and change the charging parameter. The charging power of the battery unit 165 decreases along with the progress of charging. Assuming that the sum of the power consumptions of the system devices 161, 261 is constant, the MPU 259 can set a charging parameter to charge with a larger current with time.

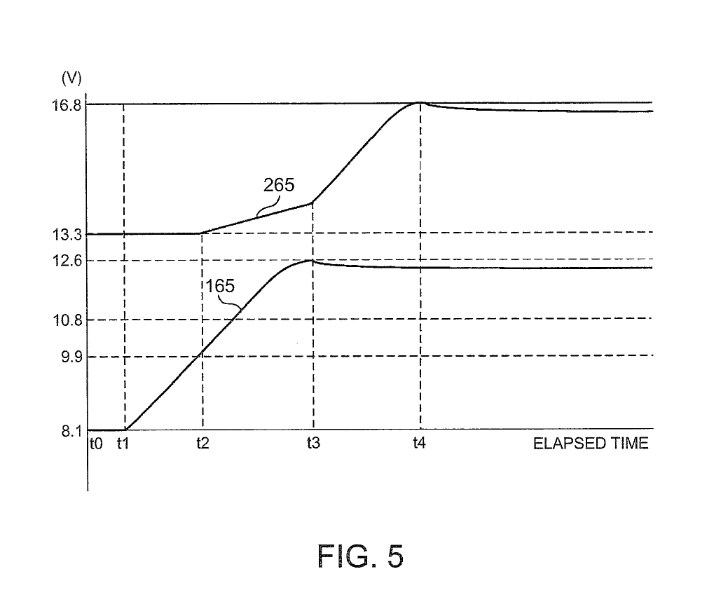

An example of voltage profiles of the battery units 165 and 265 in this case is shown in FIG. 5. In FIG. 5, since four battery cells are connected in series in the battery unit 265 and three battery cells are connected in series in the battery unit 165, there is a difference corresponding to one cell between both output voltages. Parameters regarding charging and discharging of the battery units 265 and 165 are as follows: Voltages at which the respective batteries are fully charged and hence charging is finished are 16.8 V and 12.6 V, voltages to make a transition to hibernation are 13.3 V and 9.9 V, and voltages to shut down are 10.8 V and 8.1 V, respectively.

At time t0, the voltage in the battery unit 165 is reduced up to the shutdown voltage and the voltage in the battery unit 265 is reduced up to the hibernation voltage. At time t1, charging of the battery unit 165 is first started to raise the voltage. At this time, the AC/DC adapter 252 can supply power to the system devices 161 and 261. During a period from time t1 to time t2, since there is no margin in the rated power of the AC/DC adapter 252, the MPU 259 does not charge the battery unit 265. When charging power of the battery unit 165 is reduced to give a power margin to the rated power of the AC/DC adapter 252 at time t2, the MPU 259 starts charging the battery unit 265.

Charging of the battery unit 165 is finished at time t3, and the AC/DC adapter 252 supplies a larger amount of charging power to the battery unit 165. After that, when charging of the battery unit 265 is finished at time t4, the battery units 165 and 265 maintain the fully charged state while the AC/DC adapter 252 supplies power to the system devices 161 and 261.

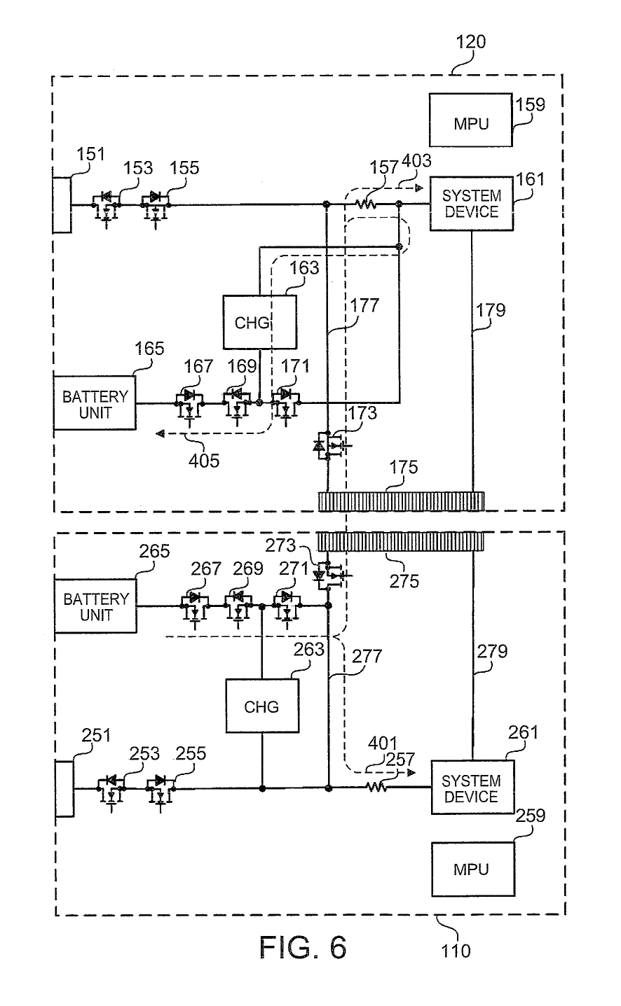

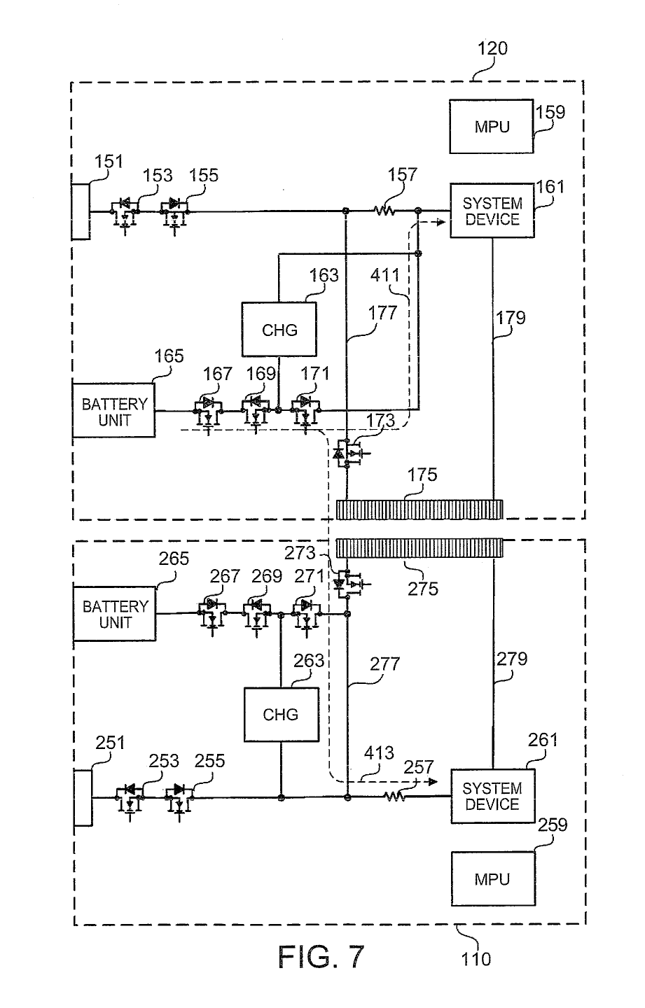

Next, operation when the AC/DC adapter 252 is not connected will be described. FIG. 6 is a diagram describing power feeding routes from the battery unit 265 in the combined state, FIG. 7 is a diagram describing power feeding routes from the battery unit 165 in the combined state, and FIG. 8 is a flowchart describing the operation of the base unit 110 and the tablet unit 120 when the AC/DC adapter 252 is not connected in the combined state.

In block 603, when it is detected that voltage is applied to the power terminal of the connector 175, the MPU 159 turns the FET 173 on. Further, the MPU 159 communicates with the MPU 259 to make sure that the AC/DC adapter 252 is not connected. When it is determined that the battery unit 265 is applying voltage to the power terminal of the connector 175, the MPU 159 turns the FETs 167 and 169 off.

Here, a power feeding method when the AC/DC adapter 252 is not connected in the combined state will be described. In this case, the power supplies for the tablet PC 100 are only the battery units 165 and 265. In order to extend the operation time of the tablet unit 120 in the detached state, it is desired to accumulate as much electricity as possible in the battery unit 165 before the tablet unit 120 is detached. To this end, the MPUs 159 and 259 control the FETs and the chargers to first discharge the battery unit 265 and then discharge the battery unit 165. Then, the battery unit 165 is charged with the power of the battery unit 265 if needed.

In block 605, the battery unit 265 supplies power to the system devices 161 and 261 through power paths 401 and 403 in FIG. 6 until the output voltage of the battery unit 265 reaches the hibernation voltage. In block 607, when a charging request is made from the battery unit 165, the MPU 159 sets a charging parameter in the charger 163 to turn the FETs 167 and 169 on and the FET 171 off in order to charge the battery unit 165. At this time, the battery unit 265 supplies charging power to the battery unit 165 through a power path 405 in FIG. 6. When charging is finished, the MPU 159 turns the FETs 167 and 169 on.

In block 609, the MPU 259 monitors the output voltage of the battery unit 265 to determine whether there is sufficient remaining capacity. When determining that there is no remaining capacity, the MPU 259 turns the FETs 267 and 269 off to stop discharging the battery unit 265 in block 611. In block 613, when the voltage on the power line 177 is detected to detect that power supply from the base unit 110 is stopped, the MPU 159 turns the FET 171 on. The battery unit 165 supplies power to the system devices 161 and 261 through power paths 411 and 413 in FIG. 7. During a period from when the FET 269 is turned off until the FET 171 is turned on, since power is supplied from a body diode of the FET 171, drops of voltage to the system devices 161 and 261 fall within acceptable values, respectively.

In block 615, when the output voltage of the battery unit 165 is reduced up to the hibernation voltage, the MPU 159 notifies the MPU 259 of that effect. Then, the MPUs 159 and 259 makes the system devices 161 and 163 transit to the hibernation state. When both the tablet unit 120 and the base unit 110 transit to the hibernation state, the MPU 159 turns the FETs 167 and 169 off to stop discharging the battery unit 165 in block 617, and the procedure returns to block 503.

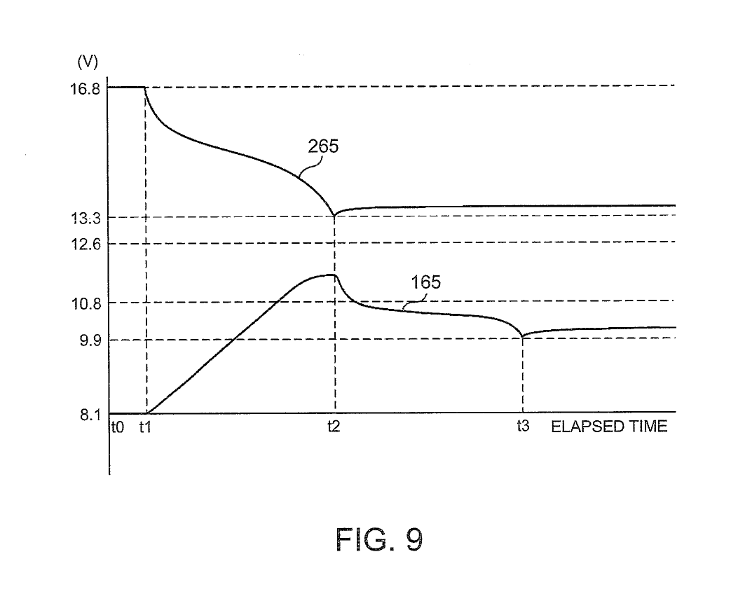

An example of voltage profiles of the battery units 165 and 265 in this case is shown in FIG. 9. In FIG. 9, parameters of the battery units 165 and 265 regarding charging and discharging are the same as those in FIG. 5. At time t0, the battery unit 165 is almost discharged to reduce the output voltage up to the shutdown voltage, and the battery unit 265 is in the fully charged state to raise the output voltage up to a charge end voltage.

At time t1, the battery unit 265 supplies power to the system devices 161 and 261, and further charges the battery unit 165. At time t2, although the output voltage of the battery unit 265 is reduced up to the hibernation voltage, since power can be further fed from the battery unit 165, both the tablet unit 120 and the base unit 110 do not transit to the hibernation state.

When the remaining capacity of the battery unit 165 is high or the power consumptions of the system devices 161 and 261 are low at time t1, the battery unit 165 is fully charged and hence the output voltage becomes the charge end voltage before time t2. At time t3, the output voltage of the battery unit 165 is reduced up to the hibernation voltage, and the MPUs 159 and 259 make the tablet unit 120 and the base unit 110 transit to the hibernation state, respectively. When the battery unit 165 is in the fully charged state or the remaining capacity is high at time t1, since the amount of charging power is reduced, the time of power feeding by the battery unit 265 during a period from time t1 to time t2 becomes longer.

The connectors 175 and 275 in the present embodiment is so configured that the power line 22 to which power is fed from the battery unit 27 and the power line 24 to which power is fed from the AC/DC adapter as shown in FIG. 10 can be integrated as an example. In this case, twelve power terminals can be reduced. Thus, since the number of reduced power terminals can be used as signal terminals, this configuration can be adapted to a variety of forms of the system device 261.

Further, since the battery unit 265 and the AC/DC adapter 252 are connected as so-called wired ORs to the power line 277 in FIG. 3, charging of the battery unit 165 with the battery unit 265 can be achieved as well as the reduction in the number of terminals. Since the battery unit 165 is charged with the battery unit 265, the battery-driven operation time of the tablet unit 120 can be lengthened when in use in an environment where the AC/DC adapter 252 cannot be connected.

For example, when the remaining capacity of the battery unit 165 is reduced while the tablet unit 120 is in use, the tablet unit 120 is attached to the base unit 110 and charged so that the tablet unit 120 can be used continuously. The embodiment of the present invention is described above by taking a hybrid PC as an example, but the present invention can also be applied to a combination of a laptop PC and a docking station for expanding the functionality, and a combination of a battery unit equipped with a charger and a battery and the laptop PC. Further, the application is not limited to the laptop PC, and the present invention can be applied to a combination of a smartphone or a tablet terminal and a function expansion device used in connection with the smartphone or the tablet terminal. In the embodiment, the MPUs carry out charging power control, FET control, and control of the output power of the AC/DC adapter, the present invention can also carry out the same control by a discrete circuit including a charger.

As has been described, the present disclosure provides a technique for reducing the number of power terminal connectors for connecting tablet unit 120 to base unit 110.

While the disclosure has been particularly shown and described with reference to a preferred embodiment, it will be understood by those skilled in the art that various changes in form and detail may be made therein without departing from the spirit and scope of the disclosure.

What is claimed is:

1. A hybrid personal computer comprising:
a first unit having
a first system device; and
a first connector including a power terminal; and
a second unit having
a second connector including a power terminal capable of being connected to said first connector when said second unit is combined with said first unit;
a second battery capable of supplying power to said first system device through said power terminal; and
an external power-supply circuit capable of supplying power of an external power supply to said first system device through said power terminal, wherein said first and second units are capable of being combined with and detached from each other.

2. The hybrid personal computer of claim 1, wherein
said first unit further includes a first battery capable of supplying power to said first system device; and
said external power-supply circuit supplies charging power of said first battery through said power terminal.

3. The hybrid personal computer of claim 2, wherein said second battery supplies charging power of said first battery through said power terminal.

4. The hybrid personal computer of claim 2, wherein
said second unit includes a second system device; and
when output voltage of said second battery is reduced less than a predetermined value while said second battery is supplying power to said first and second system devices, said first battery is capable of supplying power to said first and second system devices.

5. The hybrid personal computer of claim 4, wherein an output voltage of said second battery is kept higher than an output voltage of said first battery.

6. The hybrid personal computer of claim 4, wherein said first connector includes a signal terminal connected to said first system device through a signal line, and said second connector includes a signal terminal connected to said second system device through a signal line.

7. The hybrid personal computer of claim 2, wherein said first unit further includes an external power-supply circuit for supplying power to said first system device and further supplying charging power to said first battery in a detached state.

8. The hybrid personal computer of claim 1, wherein said first unit is a tablet terminal device, and said second unit is a base unit.

9. The hybrid personal computer of claim 1, wherein said first unit includes a display device.

10. The hybrid personal computer of claim 1, wherein said first unit is a laptop computer, and said second unit is a function expansion device.

11. A method of supplying power in a hybrid personal computer having a first unit and a second unit, said method comprising:
connecting a first connector of said first unit to a second connector of said second unit to combine said first unit and said second unit, wherein said first unit is equipped with a first power terminal and a first system device, and said second unit is equipped with a second power terminal and capable of connecting to said first connector, wherein said first unit and said second unit can be combined with and detached from each other;
causing a second battery to supply power to said first system device through said first power terminal; and
supplying power from an external power supply of said second unit to said first system device through said second power terminal.

12. The method of claim 11, wherein said first unit includes a first battery capable of supplying power to said first system device, said method further comprises:
causing said external power supply to supply power to said first system device while supplying charging power to said first battery through said power terminal; and
causing said second battery to supply power to said first system device while supplying charging power to said first battery through said first power terminal when said external power supply is not supplying power.

13. The method of claim 12, further comprising causing said first battery to supply power to said first system device after a discharging of said second battery has been completed.

14. The method of claim 12, wherein said second unit further includes a second system device, said method further comprises causing said first battery to supply power to said second system device through said second power terminal when said external power supply and said second battery are not supplying power.
